(19) United States
(12) Patent Application Publication
(10) Pub. No.: US 2008/0038657 A1
(43) Pub. Date: Feb. 14, 2008

(54) FULL COLOR IMAGE FORMING METHOD

(75) Inventors: Hiroshi YAMAZAKI, Tokyo (JP); Ken OHMURA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/781,035

(22) Filed: Jul. 20, 2007

(30) Foreign Application Priority Data
Aug. 8, 2006 (JP) 2006215414

(51) Int. Cl. G03G 13/08

(52) U.S. Cl. 430/120.4

(57) ABSTRACT

A color image forming method, comprising the steps of: forming a yellow toner image with a two component yellow developer, a light yellow toner image with a two component light yellow developer, a magenta toner image with a two component magenta developer, a light magenta toner image with a two component light magenta developer, a cyan toner image with a two component cyan developer, a light cyan toner image with a two component light cyan developer, and a black toner image with a two component black developer, and superimposing toner images. The carrier in the developer includes carrier particles in each of which a magnetic powder is dispersed in a binder resin and which have a shape coefficient SF-1 of 1.0 to 1.2, a shape coefficient SF-2 of 1.1 to 2.5 and a volume-based median size of 10 to 100 μm.

This application is based on Japanese Patent Application No. 2006-215414 filed on Aug. 8, 2006, in Japanese Patent Office, the entire content of which is hereby incorporated by reference.

### BACKGROUND OF THE INVENTION

The present invention relates to a full color image forming method by an electro-photographic system using two-component developer of not less than 7 colors.

Recently, for the electro-photographic system image forming device, it is required that the full color image of the photographic quality in which, high gradation property, wide color reproduction range, for example, as the silver halide photography are attained, is formed.

Then, when for the formation of such a photographic image full color image, in addition to 4 kinds of thick color toners of yellow, magenta, cyan, black which are conventionally used for the full color image formation, the full color image formation is conducted by using multi-color toner in which light color toners whose density levels are different each other from these thick color toners are combined, it is proposed that the attainment of the wide color reproduction range is intended, (for example, refer to the Japanese Patent O.P.I. Publication (Tokkai) No. 2004-70208).

When light color toner is combined with thick color toner and used, the area gradation property can be given to the image which is formed by dot, as the result, the color gamut is enlarged.

However, even when multi color toner is used, when in the developing property between multi color toner, high uniformity is not attained, the color gamut is varied, as a result, the high quality full color image which is an object, can not be formed.

### SUMMARY

The present invention is attained based on the condition as described above, its object is to provide the full color image forming method by which the full color image in which the wide color reproduction range is attained for a long period of time, can be formed.

The above object can be attained by the following color image forming method on which one aspect of the present invention is reflected.

A color image forming method comprises the steps of:

(1) developing a latent image with a yellow developer including a yellow toner containing a yellow colorant and a carrier to form a yellow toner image;

(2) developing a latent image with a light yellow developer including a light yellow toner containing the yellow colorant in an amount of 5 to 50% by weight of the amount of the yellow colorant contained in the yellow toner to form a light yellow toner image;

(3) developing a latent image with a magenta developer including a magenta toner containing a magenta colorant and a carrier to form a magenta toner image;

(4) developing a latent image with a light magenta developer including a light magenta toner containing the magenta colorant in an amount of 5 to 50% by weight of the amount of the magenta colorant contained in the magenta toner to form a light magenta toner image;

(5) developing a latent image with a cyan developer including a cyan toner containing a cyan colorant and a carrier to form a cyan toner image;

(6) developing a latent image with a light cyan developer including a light cyan toner containing the cyan colorant in an amount of 5 to 50% by weight of the amount of the cyan colorant contained in the cyan toner to form a light cyan toner image;

(7) developing a latent image with a black developer including a black toner containing a black colorant and a carrier to form a black toner image;

(8) superimposing at least two different color images formed by at least two steps of the steps (1) to (7) so as to form a color image;

wherein the carrier used in the steps (1) to (7) includes carrier particles in each of which a magnetic fine powder is dispersed in a binder resin and has a shape coefficient SF-1 of 1.0 to 1.2, a shape coefficient SF-2 of 1.1 to 2.5 and a volume-based median size of 10 to 100 μm.

### BRIEF DESCRIPTION OF THE DRAWINGS

FIG. 1 is a schematic diagram showing an example of a color forming apparatus including a single image carrying member 1 and a plurality of developing devices 2.

FIG. 2 is a schematic diagram showing an example of a color forming apparatus including an image carrying member 1 and developing devices 2 for each color.

### DETAILED DESCRIPTION OF THE PREFERRED EMBODIMENT

Hereinafter, preferable embodiments of the present invention will be explained, however, the present invention is not limited to these preferable embodiments.

Firstly, preferable image forming methods to attain the above objects are explained.

A full color image forming method of the present invention, includes at least; a yellow developer composed of a carrier and a yellow toner containing a yellow colorant, a light yellow developer composed of a carrier and a light yellow toner containing the yellow colorant in an amount of 5 to 50% by weight of the amount of the yellow colorant contained in the yellow toner; a magenta developer composed of a carrier and a magenta toner containing a magenta colorant, a light magenta developer composed of a carrier and a light magenta toner containing the magenta colorant in an amount of 5 to 50% by weight of the amount of the magenta colorant contained in the magenta toner; a cyan developer composed of a carrier and a cyan toner containing a cyan colorant, a light cyan developer composed of a carrier and a light cyan toner containing the cyan colorant in an amount of 5 to 50% by weight of the amount of the cyan colorant contained in the cyan toner; and a black developer composed of a carrier and a black toner containing a black colorant, and forms a full color image by superimposing color images formed respectively with above developers, wherein the carrier includes carrier particles in each of which a magnetic-substance fine powder is dispersed in a binder and which have a shape coefficient SF-1 of 1.0 to 1.2, a shape coefficient SF-2 of 1.1 to 2.5 and a volume-based median size of 10 to 100 μm.

In the full color image forming method of the present invention, the full color image may be preferably formed by superimposing a color image formed on an image carrying member by a light black developer composed of a carrier and a light black toner containing the black colorant in an amount of 5 to 50% by weight of the amount of the black colorant contained in the black toner.

According to the full color image forming method of the present invention, the carrier constituting the each color two component developer is formed of resin dispersion type carrier having specific shape (hereinafter, called also “sSHFiIiF rHsin disSHrsiRn WySH FarriHr”), bHFausH Whis specific resin dispersion type carrier has high durability, and the toner can be charged by the high uniformity, the color image by each color toner is developed stably in high uniformity, as the result, the high quality full color image in which the wide color reproduction range is stably attained for a long period of time, can be formed.

The full color image forming method of the present invention will be described below in detail.

The full color image forming method of the present invention is conducted by using two component developers not less than 7 colors in which the resin dispersion type carrier having specific shape is mixed in each of toners not less than 7 colors formed of thick toner and light toner having the coloring agent of respectively specific amount, the carrier has the magnetic substance fine powder dispersed in the binder resin.

### [Toner]

bach color toner is, respectively, the including amount of the coloring agent is specific amount, and it can be a toner in which the biding resin is included.

bach color toner can be 7 colors which is 4 color of thick color toner of, for example, yellow toner (thick color yellow toner) including yellow coloring agent used for general color image formation, magenta toner (thick color magenta toner) including magenta coloring agent, cyan toner (thick color cyan toner) including cyan coloring agent, and black toner including black coloring agent, and 3 colors of light toners of light color yellow toner including yellow coloring agent, light color magenta toner including magenta coloring agent, and the light color cyan toner including cyan coloring agent, whose density level of colorant is different from thick color toners and further, in addition to these, can be 8 colors using thin sumi ink toner (light color toner) including black coloring agent.

Then, light color toner is 5-50 mass % of the including amount of coloring agent of corresponding thick FRORr WRnHr, SrHIHrabOy, inFOudHs FRORrinJ aJHnW RI 5-30 mass %.

When the including amount of the coloring agent of light color toner is not larger than 5 mass % of the including amount of the coloring agent of corresponding thick color toner, the coloring property can not be obtained, the function as the light color toner can not be exerted.

The addition amount of each coloring agent contained in black toner, thick color yellow toner, thick color magenta toner, and thick color cyan toner is 1-30 mass % to the whROH RI WRnHr, SrHIHrabOy, ranJH RI 2-20 Pass %.

It is preferable that in the thick color toner and light color toner in each of color toners, the hue angle is mutually the same.

### [Coloring Agent]

As the coloring agent forming each color toner, publicly known inorganic or organic coloring agent can be used. Specific coloring agent will be shown below.

As black coloring agent forming black toner and thin black toner, carbon black such as furnace black, channel black, acetylene black, thermal black, lamp black, magnetic powder such as magnetite, ferrite, further, the coloring agent in which yellow coloring agent, magenta coloring agent and cyan coloring agent which will be described later, are color-adjusted to black, is listed.

As magnetic substance, metal oxide including element such as iron, cobalt, nickel, copper, magnesium, manganese, aluminum, silicon is listed, in them, it is preferable that metallic oxide in which iron oxide such as tetra tri iron oxide, γ—iron oxide is main component, is used, and from the point that the charging property of the toner can be controlled, metallic oxide in which further, metallic element such as silica, or aluminum is included may also be used. It is preferable that in these magnetic substance, BbT specific surIaFH arHa by niWrRJHn absRrSWiRn PHWhRd is SrHIHrabOy 2-30 m²/J, PRrH SrHIHrabOy, 3-28 P²/g, further, Morse hardnHss is 5-7.

These black coloring agent can be singularly used or can be used when 2 or more kinds of coloring agents are combined.

As yellow coloring agent forming thick color yellow toner and light color yellow toner, condensed azo chemical compound, isoindolynone chemical compound, anthraquinone compound azo metallic complex, methine compound, alylamide complex are listed, specifically C.I. pigment yellow 12, 13, 14, 15, 17, 62, 74, 83, 93, 94, 95, 97, 109, 110, 111, 120, 127, 128, 129, 147, 168, 174, 176, 180, 181, 191 are appropriately listed.

These yellow coloring agent can be singularly used or can be used in combination of 2 or more kinds.

As magenta coloring agent forming thick color magenta toner and light color magenta toner, condensed azo compound, diketo Pyrrolo Pyrrole compound, anthraquinine, quinacridone compound, salt group dye lake compound, naphthol compound, benzimidazolone compound, thioindigo compound, perylene compound are listed, specifically, C.I. pigment red 2. 3. 5, 6, 7, 23, 48:2, 48:3, 48:4, 57:1, 81, 81:1, 122, 144, 146, 166, 169, 177, 184, 185, 202, 206, 220, 221, 254, are appropriately, listed.

These magenta coloring agent can be singularly used or can be used in combination of 2 or more kinds.

As cyan coloring agent forming thick color cyan toner and light color cyan toner, copper phthalocyanine compound and its derivative, anthraquinone compound, salt dye lake compound are listed, specifically, C.I. pigment blue 1, 7, 15, 15:1, 15:2, 15:3, 15:4, 60, 62, 66 are appropriately listed.

These cyan coloring agent can be singularly used or can be used in combination of 2 or more kinds.

As the coloring agent of each color, an agent whose surface is modified can also be used. As the surface modification agent, conventionally, well known agent can be used, specifically, silane coupling agent, titan coupling agent, aluminum coupling agent can be preferably used.

The kind of coloring agent included in thick color toner and light color toner in each color toner, for the color phase of the thick color toner and light color toner, when its hue angle is the same, it may be the same or different.

[Manufacturing Method of Toner]

As a method for manufacturing such a toner, it is particularly not limited, a method for obtaining the ball-like toner when by using disk or multi-flow body nozzle disclosed in the Japanese Patent O.P.I. Publication (Tokkosho) No. 56-13945, the melting mixture is atomized in the air, pulverizing method, dispersion polymerization method by which, by using water medium in which monomer is soluble, and obtained polymer is insoluble, the toner particle is polymer-generated, suspension polymerization method disclosed in Tokkosho No. 36-10231, Tokkaisho No. 59-53856, Tokkaisho No. 59-61842, emulsifying polymerization method such as soap free polymerization method by which the toner particle is generated when polymerized under the existence of soluble polar polymerization initiator, mini-emulsion polymerization flocculation method, emulsifying polymerization flocculation method, dissolving suspension method, polyester molecular extension method, the other publicly known methods, can be listed.

[Drinding Method]

The grinding method is conducted as follows. That is, binder resin and coloring agent are sufficiently mixed by a mixer such as Henshel mixer, ball mil together with toner component such as die releasing agent, or charge control agent at need, melting kneaded by using a thermal kneader such as heating roll, kneader, extruder, after cooling solidified, by grinding and classifying, toner particle can be obtained.

[Suspension Polymerization Method]

The suspension polymerization method is carried out as follows. Toner constituting materials such as the releasing agent, the colorant and a radical polymerization initiator are added to a radical polymerizable monomer and dissolved or dispersed in the monomer by a sand grinder to prepare uniform monomer dispersion. After that, the above monomer dispersion is added into an aqueous medium, in which a dispersion stabilizer is previously added, and dispersed by a homomixer or an ultrasonic wave disperser to form oil droplets in the aqueous dispersion. The particle diameter of the droplet finally becomes the diameter of the toner particle. Therefore, the dispersing is controlled so that the diameter is made to desired size. The size of the dispersed droplet is preferably from 3 to 10 μm in the volume based median diameter. Thereafter, polymerization is performed by heating. After completion of the polymerization reaction, the dispersion stabilizer is removed and the resultant polymerized product is washed and dried to obtain colored particles. And then an external additive is added and mixed according to necessity. Thus toner particles can be obtained.

[Binder Resin]

When toner particles constituting the toner are produced by the crushing method or the dissolving suspension method, as the binder resin for constituting the toner, various kinds of known resin, for example, polystyrene; polymers of styrene substituents such as a poly-p-chlorostyrene and a polyvinyl toluene; styrene copolymers such as a styrene-p-chlorostyrene copolymer, a styrene-vinyltoluene copolymer, a styrene-vinyl naphthalene copolymer, a styrene-acrylate ester copolymer, a styrene-methacrylate ester copolymer, a styrene-alpha-chloromethyl methacrylate copolymer, a styrene-acrylonitrile copolymer, a styrene-vinyl methyl ether copolymer, a styrene-vinyl ethyl ether copolymer, a styrene-vinyl methylketone copolymer, a styrene-butadiene copolymer, a styrene-isoprene copolymer, a styrene-acrylonitrile-indene copolymer; a polyvinyl chloride, a phenol resin, a natural modified phenol resin, a natural resin modified maleic resin, an acrylate resin, a methacrylic resin, polyvinyl acetate, a silicone resin, a polyester resin, a polyurethane resin, a polyamide resin, a furan resin, an epoxy resin, a xylene resin, a polyvinyl butyral resin, a terpene resin, a cumarone indene resin, petroleum-based resin may be usable. As a preferable binder, a partially- or entirely-crosslinked styrene resin may be employed. These resins can be used singly or in combination of two or more kinds of them.

When the toner particles are prepared by the suspension polymerization method, mini-emulsion polymerization-coagulation method or emulsion polymerization-coagulation method, for example, the following can be used as the polymerizable monomer for forming the resin to obtain the resin for constituting the toner: A vinyl type monomer, for example, styrene or a styrene derivative such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, p-n-hexylstyrene, p-n-octylstyrene p-n-nonylstyrene, p-n-decylstyrene and p-n-dodecylstyrene; a methacrylate derivative such as methyl methacrylate, ethyl methacrylate, n-butyl methacrylate, iso-propyl methacrylate, iso-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate; an acrylate derivative such as methyl acrylate, ethyl acrylate, iso-propyl acrylate, n-butyl acrylate, t-butyl acrylate, iso-butyl acrylate, n-octyl acrylate, 2-ethylhexyl acrylate, stearyl acrylate, lauryl acrylate and phenyl acrylate; an olefin such as ethylene, propylene and iso-butylene, a vinyl halide such as vinyl chloride, vinylidene chloride, vinyl bromide, vinyl fluoride and vinylidene fluoride; a vinyl ester such as vinyl propionate, vinyl acetate and vinyl benzoate; a vinyl ether such as vinyl methyl ether and vinyl ethyl ether; a vinyl ketone such as vinyl methyl ketone, vinyl ethyl ketone and vinyl hexyl ketone; an N-vinyl compound such as N-vinylcarbazole, N-vinylindole and N-vinyl pyrrolidone; a vinyl compound such as vinylnaphthalene and vinylpyridine; and an acrylic acid or a methacrylic acid derivative such as acrylonitrile and acrylamide. These vinyl type monomers may be used singly or in combination of two or more kinds of them.

Moreover, a monomer having an ionic dissociable group is preferably used in combination with the above resin. The polymerizable monomer having an ionic dissociable group is one having a substituent such as a carboxyl group, a sulfonic acid group or a phosphoric group; concretely acrylic acid, methacrylic acid, maleic acid, itaconic acid, cinnamic acid, fumaric acid, a mono-alkyl maleate, a mono-alkyl itaconate, styrenesulfonic acid, allyl sulfosuccinate, 2-acrylamide-2-methylpropanesulfonic acid, acidphosphoxyethyl methacrylate and 3-chloro-2-acidphosphoxypropyl methacrylate are cited.

Furthermore, binder resins having crosslinked structure can be obtained by using a multifunctional vinyl compounds as the polymerizable monomer; concrete examples are divinylbenzene, ethylene glycol dimethacrylate, diethylene glycol diacrylate, diethylene glycol dimethacrylate, diethylene glycol diacrylate, triethylene glycol diacrylate, neopentyl glycol dimethacrylate and neopentyl glycol diacrylate.

As the binder resin included in the toner of two component developer used for the full color image forming method of the present invention, from the view point of the fixing property, conservation property, the resin whose glass transition point temperature (Tg) is 50-75° C., particularly, 52-70° C., is preferable. Further, as the binder resin, in the molecular weight distribution by the styrene converted molecular weight measured by the delpermiation chromatography (dPC), it is preferable that it has a SHaN Rr shRuOdHr in WhH ranJH RI 600-50,000, particularly, the peak or shoulder of the low molecular weight component is in the range of 3,000-15,000, further, a value of the ratio (Mw/Mn) of the weight average molecular weight (Mw) and the number average molecular weight (Mn) is 2-100.

Herein, the glass transition point (Tg) of the resin component is a value measured by aSC, the cross point of the base line and the inclination of heat absorption peak is the glass transition point. Specifically, by using the differential scan calorimeter, temperature rises to 100° C., after remains as it is for 3 minutes at the temperature, cools to the room temperature at the falling temperature 10° C./min. Next, when this sample is measured at the temperature rising speed 10° C./min, the cross point of the extended line of the base line less than the glass transition point, and the tangent line showing the maximum inclination between a range from the rising part of the peak to the apex of the peak, is shown as the glass transition point. Herein, as the measuring instrument, an instrument such as aSC-7 made by Parkin-elmer co. can be used.

Further, the measuring method of the molecular weight of the binder resin by dPC is as follows. That is, to a measuring sample 0.5-5 mg, for example, to 1 mg, tetrahydrofran (THF) 1 cc is added, by using magnetic staler, mixed and sufficiently dissolved in the room temperature, nH[W, aIWHr SrRFHssHd by PHPbranH IiOWHr RI bRrH si]H 0.45-0.50 μm, filled in dPC column. The measurement of dPC is conducted when the column is stabilized to the temperature 40° C., THF is flowed at the flow rate of 1 cc/min, and the sample whose density is 1 mg/cc, is filled in by about 100 μl. It is preferable that the column is used in combination with polystyrene jell-column in the market. For example, the combination of Showa-denko co. made Shodex dPC hF-801, 802, 803, 804, 805, 806, 807, the combination of To-so co. made TShge 1d1000H, d2000H, d3000H, d4000H, d5000H, d6000H, d7000H, TSh guard column, can be listed. As the detector, refractive index detector (IR detector), or rs detector can be used. The molecular weight of the sample is based on the molecular weight distribution, and calculates by using the weigh-in line made by using mono-dispersion polystyrene standard particle. As polystyrene for making the weigh-in line, it is allowable when about 10 points are used.

[Surfactant]

When the toner particle constituting the toner is prepared by the suspension polymerization method, mini-emulsion method or the emulsion polymerization, the surfactant usable for obtaining the binder resin is not specifically limited. Ionic surfactants, for example, a sulfonic acid salt such as sodium dodecylbenzenesulfonate and sodium aryl-alkyl polyether sulfonate, sulfuric acid ester salt such as sodium dodecylasulfate, sodium tetradecylsulfate, sodium pentadecylsulfate, sodium pentadecylsulfate and sodium octylsulfate, a fatty acid salt such as sodium oleate, sodium laurate, sodium caprate, sodium caprylate, sodium capronate, potassium stearate and calcium oleate can be cited as suitable examples. A nonionic surfactant such as polyethylene oxide, polypropylene oxide, a combination of polypropylene oxide and polyethylene oxide, an ester of polyethylene glycol and a higher fatty acid, an alkylphenol polyethylene oxide, an ester of higher fatty acid and polypropylene oxide and a sorbitan ester is also usable. These surfactants are used as an emulsifying agent when the toner is produced by the emulsion polymerization but they may be used for another process and another purpose.

[Dispersion Stabilizer]

When the toner particles constituting the toner are produced by the suspension polymerization method, an easily removable inorganic compound may be also used as the dispersion stabilizer. As the dispersion stabilizer, tricalcium phosphate, magnesium hydroxide and hydrophilic colloidal silica can be exemplified, and tricalcium phosphate is particularly preferred. The dispersion stabilizers can be easily decomposed by an acid such as hydrochloric acid and easily removed from the surface of toner particle.

[Polymerization Initiator]

In the case of the suspension polymerization, an oil soluble radical polymerization initiator can be used. Examples of oil-soluble polymerization initiator include an a]R WySH Rr dia]R WySH SROyPHri]aWiRn iniWiaWRr suFh as 2,2′-a]Rbis-(2,4-diPHWhyOvaOHrRniWriOH), 2,2′-a]Rbis-isRbuWyOniWriOH, 1,1′-a]Rbis(FyFORhH[anH-1-FarbRniWriOH), 2,2′-a]Rbis-4-PHWhR[y-2,4-diPHWhyOvaOHrRniWriOH and azobisisobutylonitrile, a peroxide type polymerization initiator such as benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxicyclohexyl)propane and tris-(t-butyl peroxide), and a polymer initiator having a peroxide moiety at a side-chain thereof.

[Chain-Transfer Agent]

When the toner particles constituting the toner is produced by the suspension polymerization method, mini-emulsion method or emulsion polymerization method, usually used chain-transfer agent can be used for controlling the molecular weight of the binder resin.

As the chain-transfer agent, for example, a mercaptane such as n-octylmercaptane, o-decylmercaptane and tert-dodecylmercaptane, an aster of n-octyl-3 mercaptopropionic acid, terpinolene, carbon tetrabromide and α-methylstyrene dimer are usable, without any limitation.

[Charge Controlling Agent]

A charge controlling agent may be contained in the toner particle constituting the toner according to necessity. hnown various compounds can be used as the charge controlling agent.

[Releasing Agent]

Moreover, in toner particles which constitute a toner, a releasing agent may be contained if needed. Examples of the releasing agent include a paraffin wax, a microcrystalline wax, a Fisher-Tropsch wax, a polyolefin wax, a carnauba wax, and derivatives of these. Examples of derivatives include, an oxide, a block copolymer with a vinyl monomer, and a graft modified one. Moreover, a long chain alcohol, a long chain fatty acid, an acid amide, an ester wax, a ketone, a hardening castor oil and its derivative, a vegetable based wax, an animal-based wax, a mineral-based wax, a petrolactam, etc. may be used.

[Diameter of Toner Particle]

The diameter of the toner particles is preferably from 3 to 10 μm in volume based median diameter. The particle diameter can be controlled by controlling the diameter of the dispersed oil droplet when the toner particle is formed by the suspension polymerization method.

When the volume based median diameter is within the range of from 3 to 10 μm, high reproducibility of fine lines and high quality of photographic images can be obtained, and the consumption of the toner can be reduced comparing with a toner having large diameter. The volume based median diameter of the toner particle can be determined by using the particle distribution within the range of from 2.0 to 40 μm measured by Coulter Multisizer, manufactured by Coulter Co., Ltd., using a aperture of 50 μm.

[External Additive]

A material so called as external additive may be added to the toner for improving the fluidity, electroconductivity and cleaning suitability. The external additive is not specifically limited and various kinds of inorganic fine particle, organic particle and a slipping agent can be used.

As the inorganic particle, fine particle of silica, titania or alumina are preferably used and the inorganic particles are preferably subjected to hydrophobicity providing treatment by a silane coupling agent or a titanium coupling agent. As the organic fine particle, spherical one having a number average primary particle diameter of approximately from 10 to 2,000 nm can be used. The organic fine particle of polymer such as polystyrene, poly(methyl methacrylate) or a copolymer of styrene-methyl methacrylate is usable.

The adding ratio of the external additives is from 0.1 to 5.0%, and preferably from 0.5 to 4.0%, by weight of the toner. sarious kinds of material may be used in combination as the external additive.

[Carrier]

The carrier constituting the developer is the specified resin dispersion type carrier comprising a binder resin in which magnetic fine particles are dispersed and the carrier has a shape coefficient SF-1 of from 1.0 to 1.2 and a shape coefficient SF-2 of from 1.1 to 2.5 and a volume based median diameter of from 10 to 100 μm.

[Magnetic Fine Particle]

As the magnetic fine powder constituting the specific resin dispersion type carrier, fine powder of known magnetic material, for example, a metal or metal oxide such as ferrite represented by Formula a): MO.Fe₂O₃, magnetite represented by Formula b): MFe₂O₄, an alloy of such the metal or metal oxide with a metal such as aluminum and lead can be used. In the above Formulas a) and b), M is a di- or mono-valent metal such as Mn, Fe, Ni, Co, Cu, Mg, wn, Cd and ii which can be used singly or in combination of plural kinds of them.

As the concrete magnetic fine powder, magnetite, γ-iron oxide, Mn-wn type ferrite, Ni-wn type ferrite, Ca—Mg type ferrite, ii type ferrite and Cu-wn type ferrite can be exemplified.

The content of the magnetic fine powder in the specified resin dispersion carrier is from 40 to 99%, and preferably from 50 to 70%, by weight.

The number average primary particle diameter of the magnetic fine particle is preferably from 0.1 to 0.5 μm. The number average primary particle diameter is arithmetic average of Ferre direction diameter of 100 magnetic particles measured on the electron microscopic photograph with a magnification of 10,000.

A non-magnetic metal oxide powder using single or plurality of non-magnetic metal such as Mg, Al, Si, Ca, Sc, Ti, s, Cr, Mn, Fe, Co, Sr, v, wr, Mb, Mo, Cd, Sn, Ba and Pb can be used together with the above magnetic fine powder for controlling the magnetic properties. As the concrete examples of the non-magnetic metal oxide, Al₂O₃, SiO₂, CaO, TiO₂, s₂O₅, CrO₂, MnO₂, Fe₂O₃, CoO, NiO, CuO, wnO, SrO, v₂O₃ and wrO₂ are cited.

The number average primary particle diameter of the non-magnetic metal oxide powder is preferably from 0.1 to 1.0 μm.

The content of the non-magnetic metal oxide powder in the resin dispersion type carrier is from 10 to 60%, and preferably from 20 to 40%, by weight.

The magnetic fine powder may be subjected to a oleophilizing treatment by a oleophilizing agent such as various kinds of coupling agent and higher fatty acids for raising oleophilicity and hydrophobicity.

The adding amount of the oleophilizing agent is preferably from 0.1 to 10, and more preferably from 0.2 to 6, parts by weight par 100 parts by weight of the magnetic powder.

[Binder Resin]

hnown resins can be used as the binder resin constituting the specified resin dispersion type carrier without any limitation. Concretely, various kinds of resin such as a styrene-acryl type resin, a polyester resin, a fluororesin, a phenol-formaldehyde resin, an epoxy resin, a urea resin, a melamine resin are available, and the phenol-formaldehyde resin is particularly preferred.

As the binder resin, a thermally curable resin capable of forming partially or wholly constituting three dimensionally cross linking is preferably used, by which peeling off of the binder resin and releasing of the magnetic pine particle from the carrier can be inhibited by net work formed in the resin itself. Namely, the hardness and the durability of the carrier can be raised by the use of such the crosslinkable binder resin. Therefore, the binder resin constituting the carrier is not peeled off and not transferred onto the toner so that the surface of the toner is not contaminated even when the image formation is repeated for many times and when the carrier is collided with the toner.

[Production Method of Carrier]

The specified resin dispersion carrier can be produced by a method so called polymerization method.

The specified resin dispersion type carrier produced by the polymerization method has shape of near true sphere so that the carrier contamination is inhibited and uniformity of the surface and high charge donating ability can be obtained. The shape of the carrier can be easily controlled on the occasion of the production.

When the binder resin constituting the specified resin dispersion type carrier is phenol-formaldehyde resin, for example, the carrier can be obtained by adding and dissolving or dispersing a phenol and an aldehyde as the raw material monomers and the magnetic fine particles into an aqueous medium which contains the dispersion stabilizer such as colloidal tricalcium phosphate, magnesium hydroxide and hydrophilic silica, and subjected to polymerization (addition condensation reaction) treatment in the presence of a basic catalyst.

In similar manner, a melamine resin can be obtained by using melamine and an aldehyde as the raw material monomers, an epoxy resin can be obtained by using a bisphenol and epichlorohydrin as the raw material monomers and no basic catalyst, and a urea resin can be obtained by using urea and an aldehyde as raw material monomers and no basic catalyst.

[Basic Catalyst]

As the basic catalyst to be used when the binder resin is the phenol-formaldehyde resin or the melamine resin, for example, ammonia water, and an alkylamine such as hexamethylenetetramine, dimethylamine, diethyltriamine and polyethyleneimine are applicable. The basic catalyst is preferably added in an amount of from 0.02 to 0.3 moles per mole of the phenol.

As the phenols to be used when the binder resin is the phenol-formaldehyde resin, an alkyl phenol such as phenol, m-cresol, p-tert-butylphenol, o-propylphenol, resorcinol and bisphenol A and a halogenated phenol such as one in which a part or whole of the alkyl group or the benzene ring is substituted by a chlorine atom or a bromine atom are applicable. Phenol is particularly preferable since high particle shape forming ability can be obtained.

As the aldehyde to be used when the binder resin is the phenol-aldehyde rein, formaldehyde in a form of formalin or paraformaldehyde and furfural are applicable, and formaldehyde is preferred.

The specified resin dispersion carrier also can be produced by a method so called suspension polymerization method. Namely, the binder resin can be obtained by that the magnetic fine powder is dispersed in a radial polymerizable monomer and a radical polymerization initiator was added to the resultant dispersion to prepare a carrier producing composition, and then the composition is dispersed into a form of oil droplets in an aqueous medium which contains the dispersion stabilizer such as colloidal tricalcium phosphate, magnesium hydroxide and hydrophilic silica and preferably small amount of an anionic surfactant, and then subjected to radical polymerization treatment. The diameter of the oil droplet on the occasion of dispersion is from 10 to 100 μm, and preferably from 15 to 80 μm, in volume based median diameter. The particle diameter on the occasion of dispersion becomes the particle diameter of the resultant specified resin dispersion type carrier.

[Radical Polymerizable Monomer]

As the radical polymerizable monomer for obtaining the specified resin dispersion type carrier by the suspension polymerization method, the followings are cited: A vinyl type monomer, for example, styrene and its derivative such as styrene, o-methylstyrene, m-methylstyrene, p-methylstyrene, α-methylstyrene, p-chlorostyrene, 3,4-dichlrostyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene and p-n-dodecylstyrene; a methacrylate derivative such as methyl methacrylate, ethyl methacrylate, n-butyl methacrylate, isopropyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate; an acrylate derivative such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate and phenyl acrylate; an olefin compound such as ethylene, propylene and isobutylene; a vinyl halide compound such as vinyl chloride, vinylidene chloride, vinyl bromide, vinyl fluoride and vinylidene fluoride; a vinyl ester such as vinyl propionate, vinyl acetate and vinyl benzoate; a vinyl ether such as vinyl methyl ether and vinyl ethyl ether; a vinyl ketone such as vinyl methyl ketone, vinyl ethyl ketone and vinyl hexyl ketone; an N-vinyl compound such as N-vinylcarbazole, N-vinylindole and N-vinylpyridine; a derivative of acrylic acid or methacrylic acid such as for example, acrylonitrile, methacrylonitrile and acrylamide. These vinyl type monomers can be used singly or in combination of two or more kinds of them.

[Radical Polymerization Initiator]

As the radical polymerization initiator to be used for producing the specified resin dispersion type carrier by the suspension polymerization method, an oil-soluble initiator, for example an azo type or diazo type polymerization iniWiaWRr suFh as 2,2′-a]Rbis-(2,4-diPHWhyOvaOHrRniWriOH), 2,2′-a]Rbis-isRbuWyOniWriOH, 1,1′-a]Rbis(FyFORhH[anH-1-FarbRniWriOH), 2,2′-a]Rbis-4-PHWhR[y-2,4-dimethylvaleronitrile and azobis-isobutylonitrile, a peroxide type polymerization initiator such as benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxicyclohexyl)propane and tris-(t-butyl peroxide), and a polymer initiator having a peroxide moiety at a side-chain thereof are applicable.

[Chain-Transfer Agent]

rsually used chain-transfer agent may be contained in the carrier polymerizing composition for controlling the molecular weight of the binder resin constituting the specified resin dispersion type carrier.

As the chain-transfer agent, for example, a mercaptane such as n-octylmercaptane, o-decylmercaptane and tert-dodecylmercaptane, an aster of n-octyl-3 mercaptopropionic acid, terpinolene, carbon tetrabromide and α-methylstyrene dimer are usable, without any limitation.

In the invention, the specified resin dispersion carrier may be one coated on the surface thereof by a suitable resin selected for suiting the charging amount of the toner to obtain the optimum charging property and charging amount, and high durability.

When the carrier particle is coated by the coating resin, the amount of the coating resin is preferably from 0.1 to 10%, and more preferably from 0.3 to 5%, by weight of the carrier particles to be the core of the resin coated carrier particles.

The coated amount and the state of the coating resin should be controlled so that the shape coefficients SF-1 and SF-2 are each made to the foregoing values, respectively.

[Coat Resin]

A thermoplastic or thermally curable insulating resin is suitably used as the coating resin. Concrete examples of the thermoplastic insulating resin include an acryl resin such as polystyrene, a copolymer of poly(methyl methacrylate) and a styrene-acrylic acid, a styrene-butadiene copolymer, vinyl chloride, vinyl acetate, poly(vinylidene fluoride) resin, fluorocarbon resin, perfluorocarbon resin, solvent-soluble perfluorocarbon resin, poly(vinyl alcohol), poly(vinyl acetal), polyvinylpyrrolidone, a petroleum resin, a cellulose derivative such as cellulose, cellulose acetate, cellulose nitrate, methyl cellulose, hydroxymethyl cellulose and hydroxypropyl cellulose, a novolac resin, low molecular weight polyethylene, an aromatic polyester resin such as a saturated alkyl polyester resin, poly(ethylene phthalate), poly(butylene phthalate) and polyallylate, polyamide resin, polyacetal resin, polysulfone resin, polyphenylene suofide resin and poly(ether ketone) resin.

Examples of the thermally curable insulating resin include phenol resin, a modified phenol resin, a maleic resin, an alkyd resin, an epoxy resin and an acryl resin, in concrete, an unsaturated polyester formed by condensate polymerization of maleic anhydride-terephthalic acid-polyvalent alcohol, urea resin, melamine resin, xylene resin, toluene resin, guanamine resin, melamine-guanidine resin, acetoguanamine resin, glyptal resin, furan resin, silicone resin, polyimide, polyamidoimide resin, polyetherimide resin and polyurethane resin.

These coating resins may be used singly or in combination of two or more kinds of them. Moreover, it is allowed that a curing agent is mixed in the thermoplastic insulating resin for curing the coated resin.

The method for coating such the coating resin on the specified resin dispersion type carrier particle as the core particle, a method in which a coating liquid is prepared by dissolving or dispersing the coating resin in an organic solvent and the liquid is coated on the carrier particle, and a method in which powder of the coating resin and the carrier particles are mixed to adhere the resin onto the carrier particles, are applicable.

The shape coefficient SF-1 is an index indicating the spherical degree and is 1 when the particle is truly sphere. The shape coefficient SF-2 is an index indicating the degree of fine irregularity of the surface of carrier particle, and is 1 when the surface is smooth without any irregularity.

[Shape Coefficient of Carrier]

The shape coefficients SF-1 and SF-2 can be determined by randomly taking magnified photograph of 100 particles of the carrier by a field emission scanning electron microscope S-4500, manufactured by Hitachi Seisakusho Co., Ltd., and analyzing the photograph by an image processing analyzing apparatus irwbu 3, manufactured by Nicole Co., Ltd., and then calculating the average values derived from the following Expressions (SF-1) and (SF-2).

SF-1={(MuiNd)²/(ARbA)}×(π/4) Expression (SF-1)

SF-2={(PbRI)²/(ARbA)}×(1/4π) Expression (SF-2)

In the above Expressions (SF-1) and (SF-2), MuiNd is the largest diameter of the carrier particle, ARbA is the projection area of the carrier particle and PbRI is the circumference length of the carrier particle.

The largest diameter is the width of the carrier particle for making largest the distance of a pair of parallel lines when the particle is put between these lines. The projection area is an area of the image of the carrier particle projected on a plane.

[Particle Diameter of Carrier]

The specified resin dispersion type carrier constituting the double-component of the invention has a volume based median diameter of from 10 to 100 μm, and preferably from 15 to 80 μm. The volume based median diameter of the specified resin dispersion type carrier can be typically measured by a laser diffraction type particle size distribution measuring apparatus HbROS, manufactured by Sympatec Co., Ltd., having a wet type dispersing device.

When the volume based median diameter of the specified resin dispersion type carrier is less than 10 μm, the ratio of fine particles in the distribution of carrier particles and easily image wise adheres to the photoreceptor because the magnetic force per particle is lowered. When the volume based median diameter of the specified resin dispersion type carrier exceeds 100 μm, scattering of the toner is caused because the specific surface area of the carrier particle is reduced and the toner holding force is lowered.

The magnetization strength of the specified resin dispersion type carrier is preferably within the range of from 20 to 300 emu/cm³ in a magnetic field of 1 kOe.

The ratio of the toner in the double-component developer of the invention is from 3 to 20%, and preferably from 4 to 15%, by weight of the double-component developer.

[Full Color Image Forming Method]

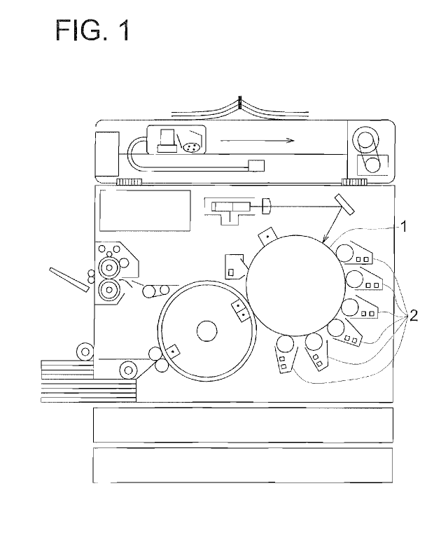

The full color image forming device for which the full color image forming method of the present invention is applied, can be a cycle system device in which it has, for example, one image carrier, and not less than 7 kinds of developing units in which two component developer of each color arranged around this image carrier are filled in, and the color image corresponding to each color is formed on the image carrier, successively the color image is transferred onto the intermediate transfer body and superposed, collectively transferred onto the recording sheet, fixed, and the full color image is formed. In FIG. 1, an example of a color forming apparatus including a single image carrying member 1 and a plurality of developing devices 2 is illustrated.

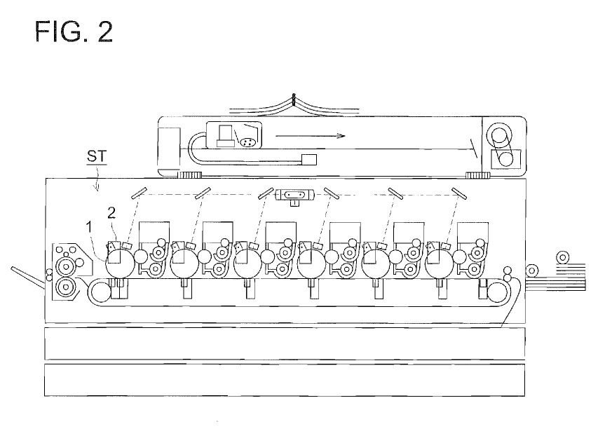

Further, for example, it may also be a drum tandem system device by which the color developing units according to each color and the image forming unit having the image carrier are respectively mounted for each color, the color image is formed for each image carrier, successively transferred on the inter mediate transfer body and superposed, collectively transferred onto the recording sheet and fixed, and the full color image is formed. In FIG. 2 an example of a color forming apparatus including a image carrying member 1 and a developing devices 2 for each color is illustrated.

As a developing system in the full color image forming method of the present invention, any one of a contact system and non-contact system can be adopted.

Further, because using two component developer hardly receives the stress, so-called toner re-cycle system by which the toner remained on the photoreceptor is recovered by the cleaning device and returned to the developing unit and is re-used, can be appropriately adopted.

Further, as the fixing system, it is particularly not limited.

[Recording Sheet]

The recording sheet used in the both-sided image forming method of the present invention is the supporting body holding the toner image, specifically, each kind of the normal sheet from thin sheet to thick sheet, quality paper, coated printing paper such as the art paper or coat paper, Japanese paper or postcard paper, the plastic film for OHP, cloth can be listed, however, it is not limited to them.

According to the above-described full color image forming method, the carrier forming two component developer of each using color is formed of specific one, because this specific resin dispersion type carrier has high durability, and can charge the toner with high uniformity, the color image by each color toner is developed stably with high uniformity, as the result, the high quality full color image in which the wide color reproduction range is stably attained for a long period of time, can he formed.

### EXAMPLES

Examples carried out for confirming the effects of the invention are described below, but the invention is not limited to the examples.

### Carrier Producing Example 1

To each of magnetite (FeO.Fe₂O₃) powder having a number average primary particle diameter of 0.24 μm and α-Fe₂O₃ powder having a number average primary average diameter of 0.60 μm, 5.5% by weight of a silane coupling agent (3-(2-aminoethylaminopropyl)dimethoxysilane) was added, respectively, and rapidly stirred at 100° C. in a stirring vessel for oleophilizing the each of the metal oxide fine particles to prepare oleophilic magnetite powder A and oleophilic α-iron oxide powder A.

Composition (1) composed of 60 parts by weight of the oleophilic magnetite powder A, 40 parts by weight of oleophilic α-iron oxide powder A, 10 parts by weight of phenol and 6 parts by weight of a formaldehyde solution containing 40% by weight of formaldehyde, 10% by weight of methanol and 50% of water was added to a flask containing an aqueous medium containing 28% by weight of NH₄OH aqueous solution and heated by 85° C. spending for 40 minutes while stirring and subjected to thermally curing reaction for 3 hours while maintaining at this temperature and then cooled by 30° C. Water was further added and the supernatant was removed and remaining precipitate was washed by water, dried by air and further dried under reduced pressure of not more than 5 mmHg at 60° C. to obtain Carrier Particle [a].

A toluene coating solution containing 10% by weiaht of silicone resin was prepared and the coating solution was coated on Carrier Particles [a] as the core by evaporating the solvent while continuously applying shearing stress to the coating solution so that the coated amount of the resin was 1.0% by weight. After that, the coated layer was cured for 1 hour at 200° C. and loosed, and then classified by a sieve of 200 meshes to obtain specified resin dispersion type Carrier [A] coated with silicone resin on the surface thereof.

The specified resin dispersion type Carrier [A] had a volume based median diameter of 34 μm, a shape coefficient SF-1 of 1.04 and a shape coefficient SF-2 of 1.51. The strength of magnetization at 1 kOe was 129 emu/cm³.

The volume based median diameter was measured by the laser diffraction type particle size distribution measuring apparatus HbROS, manufactured by Sympatec Co., Ltd., having a wet type dispersing device, and the shape coefficients SF-1 and SF-2 were determined by randomly taking magnified photograph of 100 particles of the carrier by a field emission scanning electron microscope S-4500, manufactured by Hitachi Seisakusho Co., Ltd., and analyzing the photograph by an image processing analyzing apparatus irwbu 3, manufactured by Nicole Co., Ltd., and then calculating the average values derived from the following expressions (SF-1) and (SF-2). The strength of magnetization was measured by a vibration magnetic field type automatic magnetic property recording apparatus BHs-30, manufactured by Riken aenshi Co., Ltd.

### Carrier Production Example 2

Carrier Particle [b] was obtained in the same manner as in Carrier Producing Example 1 except that Composition (2) composed of 100 parts by weight of oleophilic magnetite powder A, 10 parts by weight of phenol and 6 parts by weight of a formaldehyde solution composed of 40% by weight of formaldehyde, 10% by weight of methanol and 50% of water was used in place of Composition (1). The specified resin dispersion type Carrier [B] was prepared in the same manner as in Carrier Producing Example 1 except that the amount of the coated resin is varied to 1.5% by weight. The specified resin dispersion type Carrier [B] had a volume based median diameter of 39 μm, a shape coefficient SF-1 of 1.10 and a shape coefficient SF-2 of 1.15. The strength of magnetization at 1 kOe was 218 emu/cm³.

### Carrier Production Example 3

Carrier particle [c] was obtained in the same manner as in Carrier Producing Example 2 except that oleophilic magnetite [B] was used as the oleophilic magnetite powder, which is obtained by adding 4.5% by weight of the silane coupling agent (3-(2-aminoethylaminopropyl)dimethoxsilane) to oleophilic magnetite powder and rapidly stirred and mixing at 100° C. in the mixing vessel for providing oleophilicity to the magnetite powder. The specified resin dispersion type Carrier [C] was obtained by using the carrier particle [c] in the same manner as in Carrier Production Example 1. The specified resin dispersion type Carrier [C] had a volume based median diameter of 41 μm, a shape coefficient SF-1 of 1.04 and a shape coefficient SF-2 of 1.95. The strength of magnetization at 1 kOe was 220 emu/cm³.

### Carrier Producing Example 4

In a radical polymerizable monomer composition composed of 8 parts by weight of styrene, 2 parts by weight of 2-ethylhexyl acrylate, 1 part by weight of divinylbenzene, 60 parts by weight of the oleophilic magnetite powder A and 40 parts by weight of the oleophilic α-iron oxide were dispersed and 0.3 parts by weight of a radical polymerization initiator (lauroyl peroxide) was added to prepare a carrier forming liquid.

On the other hand, 600 parts by weight of deionized water and 500 parts by weight of a 0.1 moles/i aqueous solution of Na₃PO₄ were charged in a 2i four-mouth flask having a high speed mixing device Th type Homomixer, manufactured by Tokushu hika hogyo Co., Ltd., and a baffle plate, and heated by 65° C., and then 70 parts by weight of a 1.0 mol/i aqueous solution of CaCl₂ was gradually added while stirring at 14,000 rpm to prepare an aqueous medium containing extremely fine particle of sparingly soluble dispersion stabilizer of Ca₃(PO₁)₂. Then the carrier forming liquid was added into the aqueous medium and oil droplets of the carrier forming liquid were formed in the aqueous medium by stirring at 14,000 rpm by the high speed stirring device hT type Homomixer, manufactured by Tokushu hika hogyo Co., Ltd. After that, the stirrer was changed to a propeller type stirring wing and the system was heated by 75° C. and subjected to polymerization reaction for 8 hours. Then the system was cooled and hydrochloric acid was added to remove the dispersion stabilizer. Thereafter, the droplets were filtered, washed and dried to obtain the specified dispersion type Carrier [d].

The specified resin dispersion type Carrier [a] in the same manner as in Carrier Production Example 1 using the specific resin dispersion Carrier [d] as the core particle.

The specified resin dispersion type Carrier [a] had a volume based median diameter of 44 μm, a shape coefficient SF-1 of 1.05 and a shape coefficient SF-2 of 1.31. The strength of magnetization at 1 kOe was 129 emu/cm³.

### Comparative Carrier Production Example 1

Comparative Carrier [b] composed of silicone resin coated ii-ferrite particle prepared by a sintering method which had a shape coefficient SF-1 of 1.3 and a shape coefficient SF-2 of 2.52 was prepared. The volume based median diameter of this carrier was 45 μm.

### Comparative Carrier Production Example 2

To 100 parts by weight of polyester resin having a softening point of 150° C., 900 parts by weight of magnetite powder having a number average primary particle diameter of 0.24 μm was added, and melted and kneaded by a biaxial extruder. Then the resultant matter was crushed by a mechanical crushing machine. Thus crushed powder having a volume based median diameter of 38 μm was obtained. The shape of crushed powder was made to sphere by heating at 180° C. for 5 seconds by an instantaneous heat treating apparatus and the resultant particles were coated by the silicone resin in the same manner as in Carrier Production Example 1 to prepare Comparative Carrier [F].

The specified resin dispersion type Carrier [F] had a volume based median diameter of 39 μm, a shape coefficient SF-1 of 1.02 and a shape coefficient SF-2 of 1.04. The strength of magnetization at 1 kOe was 218 emu/cm³.

### Toner Production Example Bk1

Into a 2i four-mouth flask provided with the high speed mixing apparatus Th type Homomixer, manufactured by Tokushu hika hogyo Co., Ltd., and a baffle plate, 600 parts by weight of deionized water and 500 parts by weight of a 0.1 mols/i Na₃PO₄ aqueous solution were charged and heated by 65° C. and then 70 parts by weight of a 1.0 mol/i aqueous solution of CaCl₂ was gradually added while stirring at 12,000 rpm to prepare an aqueous medium containing extremely fine particle of sparingly soluble dispersion stabilizer of Ca₃(PO₄)₂.

On the other hand, 78 parts by weight of styrene, 22 parts by weight of 2-ethylhexyl acrylate, 7 parts by weight of carbon black, 10 parts of pentaerythritol tetra behenic acid ester were mixed and dispersion treated for 3 hours by an attriter, manufactured by Mitsui hinzoku Co., Ltd., and WhHn 8 SarWs by wHiJhW RI 2,2′-a]Rbis(2,4-diPHWhyO-valeronitrile) was added to prepare a toner forming polymerizable monomer composition.

The toner forming polymerizable monomer composition was added to the above aqueous medium and stirred at 12,000 rpm by the high speed stirring machine for 15 minutes under nitrogen atmosphere at a interior temperature of 65° C. to form toner particles. After that the stirring machine was replaced by a propeller wing stirrer, and the above resultant suspension was maintained at the same temperature for 10 hours while controlling the particle shape by the rotating rate of the stirrer wing and the angle of the baffle plate to complete the polymerization treatment. After that, the suspension was cooled and diluted hydrochloric acid was added for removing the dispersion stabilizer, and then the suspended particles were separated and repeatedly washed and dried to obtain Toner Particle (Bk-1).

Toner Particle (Bk-1) had a volume based median diameter of 6.5 μm, a peak molecular weight of 14,000, a molecular weight distribution ((Mw/Mn) of 8 and a softening point of 125° C.

The volume based median diameter was determined according to the particle size distribution within the range of from 2.0 to 40 μm measured by Coulter Multisizer, manufactured by Coulter Co., Ltd., using an aperture of 50 μm. The peak molecular weight and the molecular weight distribution were measured by gel permeation chromatography, and the softening point was measured by a hoka type flow tester.

Black Toner (Bk-1) was obtained by dry state mixing 100 parts by weight of Toner Particle (Bk-1) and silica fine powder having a BbT specific area of 140 m²/g and treated by silicone oil using a HbNSCHbi MIubR.

The shape and particle diameter of Toner Particle (Bk-1) were not varied by the addition of the silica fine particles.

### <Production Example of Toners v1 to C1>

A yellow toner v1, magenta toner M1 and cyan toner C1 were each produced in the same manner as in the toner producing example Bk-1 except that the carbon black was replaced by C. I. Pigment vellow 74, C. I. Pigment Red 122 and I. C. Pigment Blue 15:3, respectively.

### <Production Example of Toners iv1 to iC1>

A toner iv1, iM1 and iC1 with regard to a light yellow, a light magenta and a light cyan were produced in the same way in the toner producing examples v1 to C1 except that the added amount of the colorant was changed to 1.5 parts by weight.

By employing Toners Bk1 to iC1 and Carrier A to a and Comparative Carrier b and F, combining them as indicated in Table 1 and mixing them such that toner concentration was 6%, two component developers Bk1 to iC4 and comparative two component developers Bk5 to iC6 were prepared.

TABLE 1

| | | |
|---|---|---|
| aeveloper No. | Carrier No. | Toner No. |

| | | | |
|---|---|---|---|
| Inventive | Bk1 | A | Bk1 |
| | v1 | A | v1 |
| | M1 | A | M1 |
| | C1 | A | C1 |
| | iv1 | A | iv1 |
| | iM1 | A | iM1 |
| | iC1 | A | iC1 |
| | Bk2 | B | Bk1 |
| | v2 | B | v1 |
| | M2 | B | M1 |
| | C2 | B | C1 |
| | iv2 | B | iv1 |
| | iM2 | B | iM1 |
| | iC2 | B | iC1 |
| | Bk3 | C | Bk1 |
| | v3 | C | v1 |
| | M3 | C | M1 |
| | C3 | C | C1 |
| | iv3 | C | iv1 |
| | iM3 | C | iM1 |
| | iC3 | C | iC1 |
| | Bk4 | a | Bk1 |
| | v4 | a | v1 |
| | M4 | a | M1 |
| | C4 | a | C1 |
| | iv4 | a | iv1 |
| | iM4 | a | iM1 |
| | iC4 | a | iC1 |
| Comparative | Bk5 | b | Bk1 |
| | v5 | b | v1 |
| | M5 | b | M1 |
| | C5 | b | C1 |
| | iv5 | b | iv1 |
| | iM5 | b | iM1 |
| | iC5 | b | iC1 |
| | Bk6 | F | Bk1 |
| | v6 | F | v1 |
| | M6 | F | M1 |
| | C6 | F | C1 |
| | iv6 | F | iv1 |
| | iM6 | F | iM1 |
| | iC6 | F | iC1 |

### Examples 1 to 4, Comparative Examples 1 to 2

Practical copying test was carried out in which a full color image having a pixel ratio of each color of 5% was printed 50,000 sheets one by one under a high temperature and high humidity condition (32° C. and 85% RH) using each of the above obtained two-component developers Bk1 to iC4 and comparative two component developers Bk5 to iC6 in the combination shown in Table 2 by a digital copying machine bizhub Pro C350, manufactured by honica Minolta Co., itd, which was modified so as to arrange a image forming unit including a photoreceptor and a developing device for each of seven colors in tandem arrangement. The area of the color reproducible range was measured from the i*a*b* color space graph of each of the first and 50,000^{th} printed image by a color-difference meter CM-2002, manufactured by Minolta Co., Ltd. The area of color reproducible range of the 50,000^{th} print was calculated when the area of the first print was set at 100. Results are shown in Table 2.

TABLE 2

| | | Color |
|---|---|---|
| | Combination of two | reproducible |
| | component developer | range |
| Inv. bx. 1 | Bk1/v1/M1/C1/iv1/iM1/iC1 | 98 |
| Inv. bx. 2 | Bk2/v2/M2/C2/iv2/iM2/iC2 | 98 |
| Inv. bx. 3 | Bk3/v3/M3/C3/iv3/iM3/iC3 | 98 |
| Inv. bx. 4 | Bk4/v4/M4/C4/iv4/iM4/iC4 | 98 |
| Com. bx. 1 | Bk5/v5/M5/C5/iv5/iM5/iC5 | 82 |
| Com. bx. 2 | Bk6/v6/M6/C6/iv6/iM6/iC6 | 80 |

As noted from Table 2, in Examples 1 to 4 according to the full color image forming method of the present invention, it was confirmed that a wide color reproducible range has been attained in an image even after the image formation of 50,000.

What is claimed is:

1. A color image forming method, comprising the steps of:
(1) developing a latent image with a yellow developer including a carrier and a yellow toner containing a yellow colorant to form a yellow toner image;
(2) developing a latent image with a light yellow developer including a carrier and a light yellow toner containing the yellow colorant in an amount of 5 to 50% by weight of the amount of the yellow colorant contained in the yellow toner to form a light yellow toner image;
(3) developing a latent image with a magenta developer including a carrier and a magenta toner containing a magenta colorant to form a magenta toner image;
(4) developing a latent image with a light magenta developer including a carrier and a light magenta toner containing the magenta colorant in an amount of 5 to 50% by weight of the amount of the magenta colorant contained in the magenta toner to form a light magenta toner image;
(5) developing a latent image with a cyan developer including a carrier and cyan toner containing a cyan colorant to form a cyan toner image;
(6) developing a latent image with a light cyan developer including a carrier and a light cyan toner containing the cyan colorant in an amount of 5 to 50% by weight of the amount of the cyan colorant contained in the cyan toner to form a light cyan toner image;
(7) developing a latent image with a black developer including a carrier and a black toner containing a black colorant to form a black toner image;
(8) superimposing at least two different color images formed by at least two steps of the steps (1) to (7) so as to form a color image;
wherein the carrier used in the steps (1) to (7) includes carrier particles in each of which a magnetic powder is dispersed in a binder resin particle obtained by a polymerization process and which have a shape coefficient SF-1 of 1.0 to 1.2, a shape coefficient SF-2 of 1.1 to 2.5 and a volume based median size of 10 to 100 μm.

2. The color image forming method of claim 1, further comprising a step of:
developing a latent image with a light black developer including a carrier and a light black toner containing the black colorant in an amount of 5 to 50% by weight of the amount of the black colorant contained in the black toner to form a light black toner image.

3. The color image forming method of claim 1, wherein an independent image carrier is provided for each of the steps (1) to (7) and the at least two different color images are formed on at least two independent image carriers and transferred from the corresponding independent image carriers to an transfer member so that the at least two different color images are superimposed on the transfer member.

4. The color image forming method of claim 1, wherein a single common image carrier is used for the steps (1) to (7) and the at least two different color images are formed on the single common image carrier so as to be superimposed on the single common image carrier.

5. The color image forming method of claim 1, wherein each of the yellow developer, the magenta developer, the cyan developer and the black developer contains the corresponding colorant in an amount of 1 to 30% by weight.

6. The color image forming method of claim 1, wherein the binder resin constituting each of the carrier particles includes at least one resin of a styrene-acryl type resin, a polyester resin, a fluoro resin, a phenol formaldehyde resin, an epoxy resin, a urea resin, or a melamine resin.

7. The color image forming method of claim 1, wherein the binder resin constituting each of the carrier particles includes a phenol formaldehyde resin.

8. The color image forming method of claim 1, wherein each of the carrier particles is covered with a resin.

9. The color image forming method of claim 1, wherein the carrier particles have a magnetization strength of 20 to 300 emu/cm³ in a magnetic field of 1 kOe.

10. The color image forming method of claim 1, wherein the carrier particles have an electric resistance of 10⁹ to 10¹³ Ωcm.

11. The color image forming method of claim 1, wherein number average primary particle diameter of the magnetic particle is from 0.1 to 0.5 μm.

12. The color image forming method of claim 1, wherein content of the magnetic powder in each the carrier is from 40 to 99% by weight.

13. The color image forming method of claim 1, wherein each of the developer contains the toner in an amount of 3 to 20% by weight of the developer.

14. A color image forming method, comprising the steps of:
(1) developing a latent image with a yellow developer including a carrier and a yellow toner containing a yellow colorant to form a yellow toner image;
(2) developing a latent image with a light yellow developer including a carrier and a light yellow toner containing the yellow colorant in an amount of 5 to 50% by weight of the amount of the yellow colorant contained in the yellow toner to form a light yellow toner image;
(3) developing a latent image with a magenta developer including a carrier and a magenta toner containing a magenta colorant to form a magenta toner image;
(4) developing a latent image with a light magenta developer including a carrier and a light magenta toner containing the magenta colorant in an amount of 5 to 50% by weight of the amount of the magenta colorant contained in the magenta toner to form a light magenta toner image;
(5) developing a latent image with a cyan developer including a carrier and cyan toner containing a cyan colorant to form a cyan toner image;
(6) developing a latent image with a light cyan developer including a carrier and a light cyan toner containing the cyan colorant in an amount of 5 to 50% by weight of the amount of the cyan colorant contained in the cyan toner to form a light cyan toner image;
(7) developing a latent image with a black developer including a carrier and a black toner containing a black colorant to form a black toner image;
(8) superimposing at least two different color images formed by at least two steps of the steps (1) to (7) so as to form a color image;
wherein the carrier used in the steps (1) to (7) includes carrier particles in each of which a magnetic powder is dispersed in a binder resin particle and which have a shape coefficient SF-1 of 1.0 to 1.2, a shape coefficient SF-2 of 1.1 to 2.5 and a volume-based median size of 10 to 100 μm.

15. The color image forming method of claim 14, further comprising a step of:
developing a latent image with a light black developer including a carrier and a light black toner containing the black colorant in an amount of 5 to 50% by weight of the amount of the black colorant contained in the black toner to form a light black toner image.

16. The color image forming method of claim 14, wherein the binder resin constituting each of the carrier particles includes a phenol formaldehyde resin.
